(19) United States
(12) Patent Application Publication
(10) Pub. No.: US 2023/0207188 A1
(43) Pub. Date: Jun. 29, 2023

(54) DIFFERENTIAL TRANSFORMER BASED VOLTAGE CONVERTER AND METHOD THEREOF

(71) Applicants: Indian Institute of Technology Kanpur, Kanpur (IN); Virginia Tech Intellectual Properties, Inc., Blacksburg, VA (US)

(72) Inventors: Shubham SRIVASTAVA, Kanpur (IN); Mandeep Singh RANA, Kanpur (IN); Santanu K. MISHRA, Kanpur (IN); Khai D.T. NGO, Blacksburg, VA (US)

(21) Appl. No.: 17/566,063

(22) Filed: Dec. 30, 2021

(30) Foreign Application Priority Data
Dec. 27, 2021 (IN) 202111060937

(51) Int. Cl. H01F 27/34; H02M 3/335; H01F 27/24; H01F 27/32

(52) U.S. Cl. CPC H01F 27/346; H02M 3/335; H01F 27/24; H01F 27/325

(57) ABSTRACT

The system and method of converting high DC voltage input into low voltage output using DC/DC flyback converter using differential transformation technique. The said system comprises a primary winding of a transformer connected to the positive terminal of a DC supply. A primary power circuit including a MOSFET connected to the drain terminal of the MOSFET. Further, a pair of secondary winding of the transformer provided connected differentially to each other. The output voltage of the secondary side of the converter is based on the turn ratio of primary winding and the two secondary winding, wherein the two secondary windings are connected differentially with opposite polarity to each other.

### FIELD OF THE INVENTION

The present invention is in the field of voltage conversion. Particularly, the Invention provides a method and system for step down the voltage using differential transformation technique.

### BACKGROUND OF INVENTION

The following background discussion includes information that may be useful in understanding the present invention. It is not an admission that any of the information provided herein is prior art or relevant to the presently claimed invention, or that any publication specifically or implicitly referenced is prior art.

With the rapid development of semiconductors and ultra large-scale IC, the demand for low-cost isolated dc-dc converters with high current and low voltage has increased greatly. However, the conduction loss with a forward conduction voltage of approximately 0.3V has become a bottleneck in miniaturizing these converters and in improving their thermal performance. For complimenting the above problem, flyback power converters are currently some of the most common converter topologies around. This is due to the simplicity of their design and the competitive size/cost that it can deliver, especially in the mid-level power range.

Like any converter topology, a flyback converter is composed of a power path and a control path. The power path is responsible for the converting power from one type to another and is made up of the same elements as other switching power converters: two switches (a MOSFET and a diode), a capacitor, and an inductor. What sets the flyback converter apart from other converter topologies is the fact that the inductor is a pair of coupled inductors; in addition to storing power for the conversion process, these inductors add isolation between the primary side and the secondary side of the converter.

The main problem that arises with flyback converters is the preservation of isolation. As mentioned previously, one of the main advantages of flyback converters is that they include magnetic isolation between the input and the output. This divides the circuit into two halves, called the primary side and secondary side. Isolation is crucial for protecting any devices connected to the output from possible current leaks that could break the devices down, or even cause harm to end users. Consequently, isolation must be maintained, which means that there must be no conduction path connecting the primary and the secondary sides of the circuit. This is not absolute, however; voltage source transformers are normally allowed a maximum leakage of 10 mA and require isolation of at least 3 kV. But leakage between the primary and secondary sides must still be minimized as much as possible.

Usually, two regulation methods can be implemented: primary-side regulation and secondary-side regulation to control leakage. In an application, the controller IC requires an auxiliary output from the transformer to supply the IC circuitry. Due to transformer characteristics, this auxiliary transformer output is directly related to the converter's output voltage. Therefore, by knowing the transformer's turn ratio, this output can be used to regulate the system. This is called primary-side regulation (PSR), and this method enables a rough regulation of the output using very few components.

Further, in case of secondary-side regulation, this method directly senses the output voltage and sends the signal to the converter through an optocoupler, so as to transmit the signal without breaking the isolation barrier between the primary and secondary sides. Secondary-side regulation is much more accurate in comparison of primary side, even when there are one or more outputs at the secondary side. This is mainly because cross-regulation between various secondary windings is much better than it is between the primary and secondary windings. However, secondary-side regulation comes with its own set of drawbacks. For instance, SSR control loops require more components, especially if the voltage is compensated at the secondary side before being sent to the controller placed on the converter's primary side. This increases the converter's size and cost, while simultaneously reducing reliability due to the optocoupler's degradation over time.

There have been many efforts for an efficient technology to step down the voltage e.g. EP3667886 provides a DC-DC converter, which includes a controller, a first switch, a second switch, an inductor and a ripple signal generator. The controller is configured to generate an up signal and a down signal according to an output signal and a ripple signal. The first switch is coupled between an input voltage and a first node, and is controlled by the up signal. The second switch is coupled between the first node and a reference voltage, and is controlled by the down signal. The inductor is coupled between the first node and an output node, and is configured to receive a first signal from the first node to generate the output signal at the output node. The ripple signal generator is configured to generate the ripple signal, and reset the ripple signal every cycle to a specific voltage.

JP 2018-19536 discloses a power conversion device that is mounted in a vehicle, converts DC power from a battery into AC power to supply the AC power to a motor generator, and converts AC power generated by the motor generator into DC power to supply the DC power to the battery. However, there is still a need of an efficient DC/DC or AC/DC voltage converter which has better controlled output voltage, has lesser/smaller number of components, to realize high step-down function, such that the isolated DC/DC converters will have optimal implementation of high frequency transformer to minimize parasitic effect by reducing leakage inductance.

Accordingly, the present invention addresses the above-mentioned technical problem by providing a DC/DC or AC/DC converter with differential transformation technique. The claimed invention is applicable to a variety of isolated DC/DC converters to realize high step-down function, such that the isolated DC/DC converters will have optimal implementation of high frequency transformer to minimize parasitic effect by reducing leakage inductance. The DC/DC converters, based on the claimed invention, is cost effective with a smaller number of components.

### OBJECTIVE OF INVENTION AND PROPOSED SYSTEM

Primary object of the present invention is to provide a DC/DC converter to with step-down function system.

Another object of the present invention is to provide a DC/DC converter where converter is using differential transformation technique.

Another object of the present invention is to provide a DC/DC converter where high frequency transformer is used to minimize parasitic effect by reducing leakage inductance.

Another object of the present invention is to provide a DC/DC converter with flyback transformer with differential transformation technique.

Another object of the present invention is to provide a DC/DC converter with flyback transformer with differential transformation technique with two secondary winding having nearly equal windings.

Another object of the present invention is to provide a DC/DC converter with flyback transformer with differential transformation technique where the number of turns of all the windings both in primary and secondaries are almost equal.

Another object of the present invention is to provide a DC/DC converter with flyback transformer with differential transformation technique where the slight variation in the number of windings will decide the output voltage.

### SUMMARY OF THE INVENTION

The general purpose of the present invention is to provide energy efficient and cost-effective DC-DC flyback converter. The said converter has a smaller number of components in its circuitry.

Another objective of the present invention is to provide DC-DC flyback converter where leakage inductance is minimized using interleaved winding and differential arrangement of two secondary windings.

To achieve the above objectives and to fulfil the identified needs, in one aspect, the present invention provides a DC-DC flyback converter comprising:
a) a primary winding of a transformer, wherein at the primary side of the flyback converter first end of primary winding is connected to the positive terminal of a DC supply;
b) a primary power circuit including a MOSFET, wherein at the primary side of the converter second end of the primary winding is connected to the drain terminal of the MOSFET;
c) a pair of secondary winding of the transformer, wherein at the secondary side of converter the pair of secondary winding are connected differentially to each other;
d) a capacitor, wherein at the secondary side of converter the capacitor is connected parallelly to a resistive load; and
e) a diode, wherein at the secondary side of converter the diode is connected to the parallel combination of the capacitor and the resistive load;

characterized in that, output voltage of the secondary side of the converter is based on the turn ratio of primary winding and the two secondary winding, wherein the two secondary windings are connected differentially with opposite polarity to each other.

In an embodiment, the invention provides a method for converting DC power from an input power source by implementing DC-DC flyback converter and providing low power regulated DC output, the method comprising:
a) providing a primary winding of a transformer, wherein at the primary side of the flyback converter, first end of primary winding is connected to the positive terminal of a DC supply;
b) providing a primary power circuit including a MOSFET, wherein at the primary side of the converter second end of the primary winding is connected to the drain terminal of the MOSFET;
c) providing a pair secondary winding at the secondary side of converter, wherein the pair of secondary winding are connected differentially to each other;
d) providing a capacitor at the secondary side of converter, wherein the capacitor is connected parallelly to a resistive load; and
e) providing a diode at the secondary side of converter, wherein the diode is connected to the parallel combination of the capacitor and the resistive load;

characterized in that, output voltage of the secondary side of the converter is based on the turn ratio of primary winding and the two secondary winding, wherein the two secondary windings are connected differentially with opposite polarity to each other.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

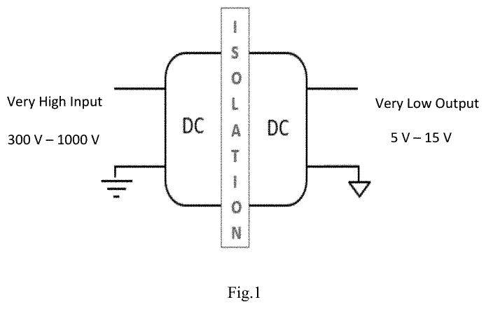

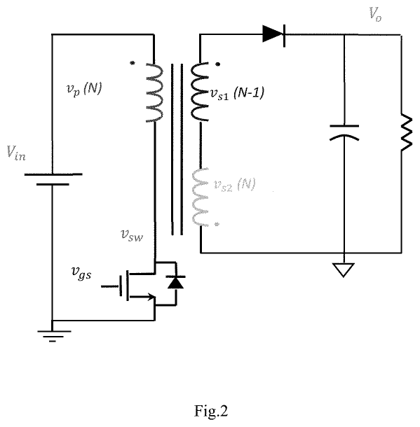

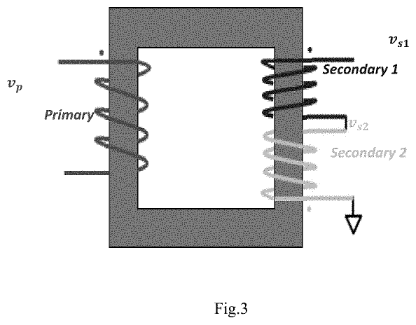

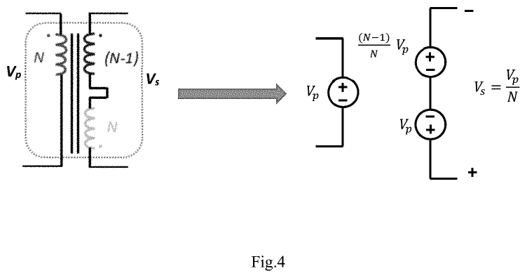

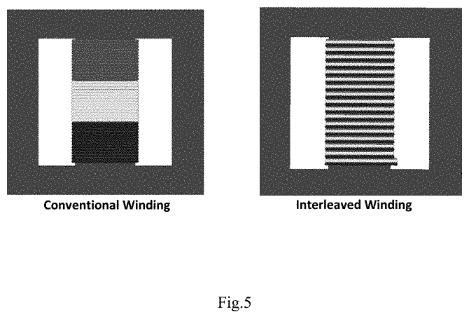

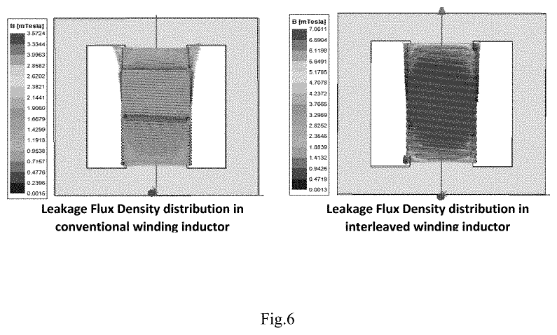

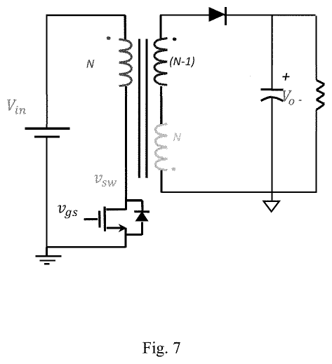

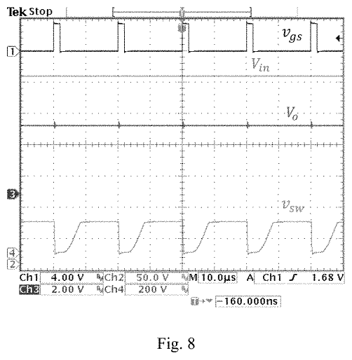

The advantages and features of the present disclosure will become better understood with reference to the following detailed description and claims taken in conjunction with the accompanying drawing, in which:
a) FIG. 1 illustrates basic block diagram of high step-down DC/DC converter with Galvanic Isolation, in accordance with certain exemplary embodiments of the present invention;
b) FIG. 2 illustrates an implementation of flyback transformer using Differential Transformation Technique, in according to various embodiments of the present invention;
c) FIG. 3 illustrates a cross section view of C-Core transformer for Differential Transformation Technique, according to various embodiments of the present invention;
d) FIG. 4 illustrates a magnetic coupling in differential transformation technique, according to various embodiments of the present invention;
e) FIG. 5 illustrates a comparison of conventional transformer winding with interleaved winding, according to various embodiments of the present invention;
f) FIG. 6 illustrates a comparison of leakage flux density distribution of conventional winding transformer and interleaved winding transformer, according to various embodiments of the present invention;
g) FIG. 7 illustrates a functional circuit of flyback converter using differential transformation technique, according to various embodiments of the present invention; and
h) FIG. 8 illustrates a graphical representation result obtained by the functional circuit of output of flyback converter using differential transformation technique, according to various embodiments of the present invention.

### DETAILED DESCRIPTION OF THE DISCLOSURE

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

The terms “a” and “an” herein do not denote a limitation of quantity, but rather denote the presence of at least one of the referenced item.

The terms “having”, “comprising”, “including”, and variations thereof signify the presence of a component.

The Invention, in a major aspect provides a Differential transformation technique to realize a high step-down DC/DC converter. The technique applies to a variety of isolated DC/DC converters to realize a high step-down function. This method can be used for many popular isolated converters, such as flyback converter, full-bridge converter, etc. The Invention is useful for power distribution system.

The Invention provides DC/DC converter that converts a high DC voltage (300-1000 V or higher) to a low DC voltage (5-15 V) level.

It will be appreciated that the DC/DC converter converts high DC voltage to a low DC voltage using differential transformation technique. The transformer used in the DC/DC converter is a three-winding transformer, wherein the three winding consist of a primary winding and two secondary windings. The winding of the transformer is arranged in an interleaved pattern. The said interleaved pattern ensures less loss of the magnetic flux.

In an embodiment, the Invention provides DC/DC converters with galvanic isolation to ensure reliable operation in case of floating loads as the source and loads are electrically isolated. It also protects the system against certain types of ground faults.

In an embodiment, the Invention provides a DC/DC converter where converter is using differential transformation technique.

In an embodiment, the Invention provides a DC/DC converter where high frequency transformer is used to minimize parasitic effect by reducing leakage inductance.

The present invention has been described with specific reference to Flyback converter, as a preferred embodiment of the Invention. However, the technology described in the present invention is applicable to any power converter like Full bridge converter, DC/DC converter etc.

In an embodiment voltage converter, comprises following components:
a) a primary winding of a transformer, wherein at the primary side of the voltage converter like flyback converter, first end of primary winding is connected to the positive terminal of a DC supply;
b) a primary power circuit including a MOSFET, wherein at the primary side of the converter second end of the primary winding is connected to the drain terminal of the MOSFET;
c) a pair of secondary winding of the transformer, wherein at the secondary side of converter the pair of secondary winding are connected differentially to each other;
d) a capacitor, wherein at the secondary side of converter the capacitor is connected parallelly to a resistive load; and
e) a diode, wherein at the secondary side of converter the diode is connected to the parallel combination of the capacitor and the resistive load;
wherein the output voltage of the secondary side of the converter is based on the turn ratio of primary winding and the two secondary winding, wherein the two secondary windings are connected differentially with opposite polarity to each other.

In an embodiment, the invention provides a method for converting DC power from an input power source by implementing DC-DC flyback converter and providing low power regulated DC output, the method comprising:
f) providing a primary winding of a transformer, wherein at the primary side of the flyback converter, first end of primary winding is connected to the positive terminal of a DC supply;
g) providing a primary power circuit including a MOSFET, wherein at the primary side of the converter second end of the primary winding is connected to the drain terminal of the MOSFET;
h) providing a pair secondary winding at the secondary side of converter, wherein the pair of secondary winding are connected differentially to each other;
i) providing a capacitor at the secondary side of converter, wherein the capacitor is connected parallelly to a resistive load; and
j) providing a diode at the secondary side of converter, wherein the diode is connected to the parallel combination of the capacitor and the resistive load;
characterized in that, output voltage of the secondary side of the converter is based on the turn ratio of primary winding and the two secondary winding, wherein the two secondary windings are connected differentially with opposite polarity to each other.

Referring to FIG. 1, there is a diagram of DC-DC flyback converter with galvanic isolation, DC-DC converter of the present invention work as a high step-down DC/DC converter configured to convert a high DC voltage (300-1000 V or higher) to a low DC voltage (5-15 V) level.

In an embodiment, galvanic isolation in DC/DC converters ensures reliable operation of floating loads as the source and loads are electrically isolated. It also protects the system against certain types of ground faults. Galvanic isolation is a general requirement for bias circuits in high voltage applications. In working, when the current flowing through primary winding is cut off, the energy stored in the magnetic field is released by a sudden reversal of the terminal voltage and transferring of energy to the secondary side happens only when primary switch is off.

Reference is now made to FIG. 2, which depicts implementation of flyback transformer using Differential Transformation Technique, the flyback converter configuration of present invention works by storing energy in the form of magnetic field during the first cycle when the MOSFET is ON and then releasing it through the diode to the load when the MOSFET is OFF.

In an embodiment, the switching device such as the MOSFET is turned on and off usually by a pulse-width-modulated signal. The transformer polarity is usually reversed such that when the MOSFET is on, current flows in the primary winding, however, the secondary diode is reverse biased, and current does not flow in this winding. The energy is stored in the primary winding of transformer until when the MOSFET is turned off. The stored energy produces a current that forward biases the diode which rectifies it to produce a DC output.

In an embodiment, the differential transformation technique provides very high step down in voltage from primary side to secondary side as the two secondaries are connected differentially. The differential transformation technique also ensures very low leakage inductance of the transformer.

In an embodiment, when the switch is closed (MOSFET on-state), the in-rush of supply current charges the primary transformer coil. In this state, power is supplied to the load by the capacitor and no current flows through the diode, as it is reverse biased. Because the capacitor alone provides power to the load during the on-state.

When the switch is opened, current is prevented from flowing in the primary circuit, and the energy stored in the primary coil is forced into the secondary circuit. The diode, now forward biased, allows the secondary winding to deliver current to the load as well as recharge the capacitor for the next switching cycle.

In an embodiment, the transformer used in the flyback DC-DC converter have equal number windings in primary side and secondary side of the transformer. The equal number of windings in the primary and one pair of secondary windings which are connected differentially with opposite flux ensures smooth operation of voltage conversion from very high input voltage to very low secondary voltage.

Advantageously, the number of turns in all the three windings are nearly equal which results in very low leakage inductance of the transformer.

In an embodiment, one end of the primary winding is connected to the positive terminal of DC supply and the other end is connected to the drain terminal of MOSFET, the source terminal of MOSFET is connected to the negative terminal of DC supply which completes the circuit connection on the primary side of the converter.

In an embodiment, voltage conversion in the transformer of the flyback DC-DC converter follows the principle of number turns of the winding wherein, at the secondary side of the converter two secondary windings are connected in a differential fashion (dots are on opposite side). The turns ratio of the transformer of the present invention is N:(N−1):N where “N” represents turns in primary winding and (N−1):N represents turns in two secondary windings, secondary 1 and secondary 2 respectively and their voltage conversion ratio.

Reference is now made to FIG. 3, which illustrates a cross section view of C-Core transformer for easy visualization of working of transformer. Usually, there are two coils primary coil and secondary coil on the transformer core. The core laminations are joined in the form of strips. The two coils have high mutual inductance. When an alternating current pass through the primary coil it creates a varying magnetic flux. As per faraday's law of electromagnetic induction, this change in magnetic flux induces an emf (electromotive force) in the secondary coil which is linked to the core having a primary coil. Specifically, number of turns winding of the transformer are varied to make transformer step up or step-down transformer.

Reference is now made to FIG. 4, which shows how the magnetic design can be electrically represented to analyze the system of the present invention. Here, instead of one secondary there are two secondaries with nearly equal windings which are coupled in a differential fashion to get the output. The number of turns of all the windings both in primary and secondaries are almost equal, as seen in the schematic. The slight variation in the number of windings (N:N−1:N) will decide the resulting output voltage.

Reference is now made to FIGS. 5 & 6, which depicts a comparison of conventional transformer winding with the interleaved winding. In conventional winding, the three windings are placed side by side on the bobbin or one after the other in concentric circle on the bobbin. In contrast, as far as interleaved winding is concerned, the three windings are bunched together in an interleaved manner and then placed concentrically on the bobbin. The interleaved winding leads to very low leakage inductance in DTT transformer realization. The comparison of leakage flux density distribution of conventional winding transformer and interleaved winding transformer using has been performed using Ansys Maxwell simulation. The dark blue color indicates the concentration of flux around the winding and minimal leakage. Below table shows the simulation verification data of conventional winding design and interleaved winding design.

| | |
|---|---|
| Conventional | Interleaved |
| Winding Design | Winding Design |

| | | | | |
|---|---|---|---|---|
| L_{primary} | 1480.157 | uH | 1451.675 | uH |
| L_{secondary1} | 1461.74 | uH | 1451.33 | uH |
| L_{secondary2} | 1466.463 | uH | 1451.328 | uH |
| M_{prim-sec1} | 1452.356 | uH | 1451.155 | uH |
| M_{sec1-sec2} | 1444.08 | uH | 1451.037 | uH |
| M_{prim-sec2} | 1432.93 | uH | 1451.038 | uH |
| leak_{prim-sec1} | 18.563 | uH | 0.347 | uH |
| leak_{sec1-sec2} | 20.019 | uH | 0.291 | uH |
| leak_{prim-sec2} | 40.364 | uH | 0.463 | uH |

The comparison of ANSYS MAXWELL results for N=16 is given in the above table and the results show superior performance for the proposed interleaved winding technique as the leakage inductance is orders of magnitude smaller for interleaved winding-based transformer. The leakage flux distribution with conventional and interleaved winding is shown in FIG. D.1. which shows that the leakage flux in case of interleaved winding inductor is smaller.

Reference is now made FIGS. 7 & 8, which shows a circuit diagram of flyback converter using differential transformation technique. One end of the primary winding is connected to the positive terminal of DC supply and the other end is connected to the drain terminal of MOSFET, the source terminal of MOSFET is connected to the negative terminal of DC supply which completes the circuit connection on the primary side of the converter. On the secondary side of the converter, the two secondaries are connected in flux opposing mode. The anode terminal of diode is connected to one end of the secondary winding and the cathode terminal of diode is connected to the parallel combination of filter capacitor and load which is further connected to the other end of the secondary winding which completes the circuit connection on secondary side of the converter.

In FIG. 8, a graphical representation result obtained by the functional circuit of flyback converter using differential transformation technique. v_{gs} is the gate to source voltage applied to turn ON the MOSFET. The MOSFET is on when V_{gs} is high and off when v_{gs} is low. Vᵢₙ is the DC supply voltage, Vₒ is the output terminal voltage across resistive load, and V_{sw} is the drain to source voltage of the MOSFET. The switch voltage shows the maximum voltage stress across the switch during steady state operation.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the present invention.

We claim:

1. A differential transformer based DC-DC voltage converter comprising:
a) a primary winding of a transformer, wherein at the primary side of the converter first end of primary winding is connected to the positive terminal of a DC supply;
b) a primary power circuit including a MOSFET, wherein at the primary side of the converter second end of the primary winding is connected to the drain terminal of the MOSFET;
c) a pair of secondary winding of the transformer, wherein at the secondary side of converter the pair of secondary winding are connected differentially to each other;
d) a capacitor, wherein at the secondary side of converter the capacitor is connected parallelly to a resistive load; and
e) a diode, wherein at the secondary side of converter the diode is connected to the parallel combination of the capacitor and the resistive load;
characterized in that, output voltage of the secondary side of the converter is based on the turn ratio of primary winding and the two secondary winding, wherein the two secondary windings are connected differentially with opposite polarity to each other.

2. The converter as claimed in claim 1, wherein when the MOSFET is in ON state the input voltage is applied across the primary winding of the transformer and current forms at the primary side of the converter and energy stored at the primary side of the transformer.

3. The converter as claimed in claim 1, wherein when MOSFET is in OFF state the magnetic energy stored in the primary winding of the transformer starts releasing stored magnetic energy to the two secondary winding of the transformer.

4. The converter as claimed in claim 3, wherein the said transferred magnetic field to the two secondary winding of the transformer forms voltage the secondary side of the converter and makes diode forward biased gives output voltage.

5. The converter as claimed in claim 1, wherein the turns of the primary winding and two secondary windings are nearly equal in number, wherein turns ratio of windings are N:(N−1):N where N represents turns in primary winding and (N−1):N represents turns in two secondary windings, secondary 1 and secondary 2 respectively and their voltage conversion ratio, where at least three windings are bunched together in an interleaved manner and then placed concentrically on the bobbin.

6. A method for converting DC power from an input power source by implementing the converter as claimed in claim 1 for providing low power regulated DC output, the method comprising:
a) providing a primary winding of a transformer, wherein at the primary side of the converter, first end of primary winding is connected to the positive terminal of a DC supply;
b) providing a primary power circuit including a MOSFET, wherein at the primary side of the converter second end of the primary winding is connected to the drain terminal of the MOSFET;
c) providing a pair secondary winding at the secondary side of converter, wherein the pair of secondary winding are connected differentially to each other;
d) providing a capacitor at the secondary side of converter, wherein the capacitor is connected parallelly to a resistive load; and
e) providing a diode at the secondary side of converter, wherein the diode is connected to the parallel combination of the capacitor and the resistive load;
characterized in that, output voltage of the secondary side of the converter is based on the turn ratio of primary winding and the two secondary winding, wherein the two secondary windings are connected differentially with opposite polarity to each other.

7. The method as claimed in claim 6, wherein when the MOSFET is in ON state the input voltage is applied across the primary winding of the transformer and current forms at the primary side of the converter and energy stored at the primary side of the transformer.

8. The method as claimed in claim 6, wherein when MOSFET is in OFF state the magnetic energy stored in the primary winding of the transformer starts releasing stored magnetic energy to the two secondary winding of the transformer.

9. The method as claimed in claim 8, wherein the said transferred magnetic field to the two secondary winding of the transformer forms voltage the secondary side of the converter and makes diode forward biased gives output voltage.

10. The method as claimed in claim 6, wherein the turns of the primary winding and two secondary windings are equal in number and three windings are bunched together in an interleaved manner and then placed concentrically on the bobbin.
